(19) United States
(12) Patent Application Publication
(10) Pub. No.: US 2009/0154762 A1
(43) Pub. Date: Jun. 18, 2009

(54) Method and system for 2D image transformation with various artistic effects

(75) Inventors: Yoon-Seok Choi, Daejeon (KR); Bon Ki Koo, Daejeon (KR); Ji Hyung Lee, Daejeon (KR); Bo Youn Kim, Daejeon (KR); Hee Jeong Kim, Daejeon (KR); Il Kyu Park, Daejeon (KR); Seung Wook Lee, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/314,858

(22) Filed: Dec. 17, 2008

(30) Foreign Application Priority Data
Dec. 17, 2007 (KR) 10-2007-0132855

(51) Int. Cl. G06K 9/00

(52) U.S. Cl. 382/100

(57) ABSTRACT

Disclosed is an image transforming method. A 2D image photographed by a digital camera is transformed into an artistic image through image transformation performed by a computer so that a natural image such as an oil painting, a pen illustration, a cartoon, a dual picture, and a template mosaic as if a person directly depicts can be provided. In the transformation of the 2D image by various artistic effects, the procedure of creating the artistic image is displayed on a screen as if a person works so that a user can view the procedure of creating the artistic image and can be interested in the artistic image.

### CROSS-REFERENCE(S) TO RELATED APPLICATIONS

The present invention claims priority of Korean Patent Application No. 10-2007-0132855, filed on Dec. 17, 2007, which is incorporated herein by reference.

### FIELD OF THE INVENTION

The present invention relates to an image transforming method and, more particularly, to method and system for transforming a two-dimensional image photographed by a digital camera into an artistic image through image transformation by a computer to create a unique content.

This work was supported by the IT R&D program of MIC/IITA [2005-S-082-03, Development of Non-Photorealistic Animation Technology].

### BACKGROUND OF THE INVENTION

In recent years, computer graphics and development of multimedia devices using the same provide an environment in which people can easily utilize authoring tools to create various desired images.

The digital camera may be one of the authoring tools for various images, almost all modern people have digital cameras now and utilize the digital camera in various uses of storing photographs captured by themselves with their digital cameras in a computer recording medium, of creating an electronic album, and of printing the photographs for keeping.

However, in the printing of the photographs shot by himself/herself to keep in an album or frames and the storing of the same to create an electronic album, the photographs are used in the state as shot by the digital camera and this does not provide feeling beyond the memory of the past experience.

Thus, there are demands for various methods enabling to provide various effects as if a person directly paints a picture to the simple 2D image.

Non-photorealistic rendering is used as a method of providing various effects to the 2D image, for example there are existing softwares providing similar effects such as Photoshop, Paint shop pro, etc.

However, since the existing methods depend on pixel-based image processing, the existing methods have a limit to transform the 2D image into a natural image such as that a person directly paints when it is desired to provide effects such as oil painting, pen illustration, cartoon, template mosaic, and the like to the 2D image.

### SUMMARY OF THE INVENTION

It is, therefore, an object of the present invention to provide an image transformation method and a system of providing an effective oil painting rendering to effectively depict a character in a portrait by stroke-based oil painting and a mosaicing template for creating a mosaic using arbitrary free style images so as to provide a natural image such as an oil painting, a pen illustration, a cartoon, a dual picture, a template mosaic, as if a person directly paints it themselves such that a user can create his/her own contents.

The present invention also provides an image transformation method and system for providing a result image using various non-photorealistic renderings including the above-mentioned rendering and a moving picture capturing the procedure of creating the result image to a user such that the user can view the procedure of creating the image by applying artistic effects to a 2D image.

In accordance with an aspect of the present invention, there is provided an image transforming method of providing an image transformation service by applying a plurality of non-photorealistic transforming effects to an input image of a user, the method includes receiving a request for an image transformation through a wired/wireless network from the user, performing the image transformation at a user's terminal or a server according to a user's circumstance, and creating a result image applied with the non-photorealistic image transforming effects. The method further includes creating a moving picture capturing a procedure of applying the non-photorealistic image transforming effects after creating the result image. In the step of creating the result image, when the non-photorealistic image transforming effects are applied, face recognition is applied to assign additional strokes to a face portion of a character in the input image containing the character such that depiction of the character is enhanced. In the step of creating the moving picture, a procedure of creating the result image by applying a template mosaic and oil painting is stored in the form of a moving picture. The method further includes transmitting the moving picture capturing the procedure of creating the result image to a corresponding user through e-mail. In the step of creating the result image, arbitrary free type tile images are applied to the input image to create a template mosaic image using a template of the tile images. A template mask is created by extracting the template of the tile images. An energy mask, an edge mask, and a writing mask are created from the input image. Positions of the tile images are determined based on the energy mask, the edge mask, and the writing mask so as to adjust tile overlapping between the respective tile images during the creation of the template mosaic image. The template mosaic image is created by dividing the input image into divisional areas by analyzing the input image and filling the divisional areas with a flood filling method, selectively reducing a size of the tile images at edges of the divisional areas based on the energy mask and the edge mask, determining a position where the tile images are piled up one on another by comparing the result image with the input image so as to enhance detailed depiction of the result image, and determining whether the overlap of the tile images is allowed based on a mask combining the energy mask with the writing mask. In the step of dividing the image and filling the divisional areas, the energy mask, the edge mask, and the writing mask are used, and in the step of determining a position and determining whether the overlap of the title images is allowed, the energy mask and the writing mask are used.

In accordance with another aspect of the present invention, there is provided an image transforming system for providing an image transforming service by applying a plurality of non-photorealistic transforming effects to a two-dimensional input image of a user, the image transforming system includes a rendering server transforming the two-dimensional input image into a desired image by applying non-photorealistic rendering to the two-dimensional input image, a user terminal requesting the non-photorealistic rendering to the two-dimensional input image, and a web server transmitting the request to the rendering server according to specification of the user terminal when the request is received and transmitting a result image to the user terminal, or transmitting an image transforming program to the user terminal such that the two-dimensional input image is transformed in the user terminal.

According to the image transforming method of the present invention, a 2D image photographed by a digital camera is transformed into an artistic image through image transformation performed by a computer so that a natural image such as an oil painting, a pen illustration, a cartoon, a dual picture, and a template mosaic as if a person directly depicts can be provided. In the transformation of the 2D image by various artistic effects, the procedure of creating the artistic image is displayed on a screen as if a person works so that a user can view the procedure of creating the artistic image and can be interested in the artistic image.

### BRIEF DESCRIPTION OF THE DRAWINGS

The above and other objects and features of the present invention will become apparent from the following description of embodiments given in conjunction with the accompanying drawings, in which:

FIG. 1 is a diagram illustrating an overall service system according to an embodiment of the present invention;

FIG. 2 is a sequence diagram illustrating an image creating procedure to which a high-end terminal based artistic transformation effect is applied in the system according to an embodiment of the present invention;

FIG. 3 is a sequence diagram illustrating a service of artistic transformation effect based on a low-end terminal in the system according to an embodiment of the present invention;

FIG. 4 is a sequence diagram illustrating image transformation of accurately depicting a character using oil painting in a portrait according to an embodiment of the present invention;

FIG. 5 is exemplary images illustrating the creation of an image using artistic rendering according to an embodiment of the present invention;

FIG. 6 is exemplary images illustrating a procedure of the creation of image mosaic based on a template according to an embodiment of the present invention;

FIG. 7 is an exemplary view illustrating the principle of operating a mask to adjust overlap of respective tile images within a template mosaic according to an embodiment of the present invention;

FIG. 8 is a view illustrating exemplary images in steps of creating a mosaic in a template based image according to an embodiment of the present invention;

FIG. 9A to 9C are a view illustrating various result images created by the template mosaic according to an embodiment of the present invention; and

FIGS. 10A to 10I are views illustrating exemplary result images created by artistic techniques according to an embodiment of the present invention.

### DETAILED DESCRIPTION OF THE EMBODIMENTS

Hereinafter, exemplary embodiments of the present invention will be described in detail with reference to the accompanying drawings. Detailed descriptions of well-known functions and structures incorporated herein may be omitted to avoid obscuring the subject matter of the present invention. The terms used herein are those defined in consideration of the functions of the present invention and may be different according to intentions and customs of a user or a manager. Therefore, the definitions of the terms will be fixed on the basis of the entire content of the specification.

According to features of the present invention, a 2D image photographed by a digital camera is transformed by various artistic techniques through an image transformation using a computer, such that a user creates his/her unique content so that the purpose of the present invention can be easily achieved.

The present invention provides a system for providing rendering for receiving a photograph and transforming the same into an image with artistic effects, such as one an artist created, using non-photorealistic rendering such as a cartoon, template mosaic, pen style illustration, oil painting, a dual picture, and the like, and services using the rendering.

Overall concept of the system is to use a target image to which the user wishes to apply the artistic transforming effects through a wired or wireless network and to obtain a finally transformed image through operation with a calculation server. In this case, the transformation is changed according to performance of a terminal that the user uses through the network. When the user uses a personal digital assistant (PDA) or a mobile phone with a low performance as a terminal, an image is transmitted to the calculation server for the artistic transformation such that the calculation server performs the image transformation and the result of the transformation is delivered to the terminal. In this case, since a moving picture capturing the procedure of creating the image is large, the moving picture is transmitted to a corresponding input e-mail address of the user rather than directly transmitted to the terminal. This is because of considering a charge for using a wireless network rather than transmission rate of the wireless network.

Hereinafter, operation of the system and how to use the respective artistic techniques will be described with reference to the drawings.

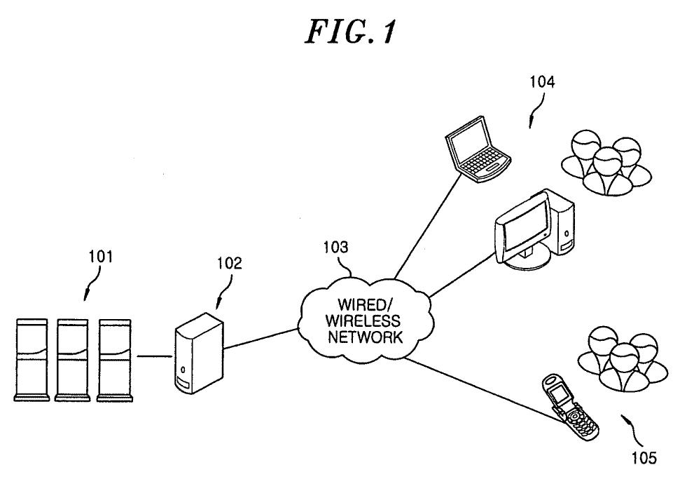

FIG. 1 is a diagram illustrating configuration of an image transforming service system according to an embodiment of the present invention. The image transforming service system for providing artistic images includes a rendering server, a web server, a wired/wireless network, and user terminals.

In view of operation, the rendering server 101 is a calculation server processing image rendering, and the web server 102 is a user-to-user web-based service server. The wired/wireless network 103 transmits an image transformation demand from the users and a result transformed into the artistic image to the rendering server 101 and user terminals 104 and 105. The user terminals 104 and 105 include a first user terminal 104 having a high-end central processing unit such as a desk-top computer, a laptop computer, and the like, and a second user terminal 105 with a low performance such as a portable PDA, mobile phone, and the like.

When the high-end first user terminal 104 requests the image transformation to the web server 102, the web server 102 transmits an image transformation program to the first user terminal 104 such that the first user terminal 104 creates an image. Alternately, when the low-end second user terminal 105 transmits a photograph through the network 103, the web server 102 requests the image transformation to the rendering server 101 and the rendering server 101 creates a result image and a moving picture capturing the procedure of creating the result image and transmits the same to the web server 102. When the user requests the moving picture, the web server 102 transmits an e-mail to the user.

A user's circumstance may be determined by the performance such as a clock frequency of a central processing unit of the user terminals 104 and 105. Thus, the user terminals 104 and 105 may be divided into the high-end user terminal 104 (e.g. a desk-top computer and a laptop computer) and the low-end user terminal 105 (e.g. a portable PDA and a mobile phone) based on the performance of the user terminal such as the clock frequency of the central processing unit of the user terminal. The high-end user terminal 104 is the terminal which may perform a sufficient artistic transformation of the image. The low-end user terminal 105 is the terminal which may perform an insufficient artistic transformation of the image. The performance information of the user terminal may be sent to the web server 102 when the user requests the transformation of the image or the performance of the user terminal may be registered prior to requesting the transformation of the image.

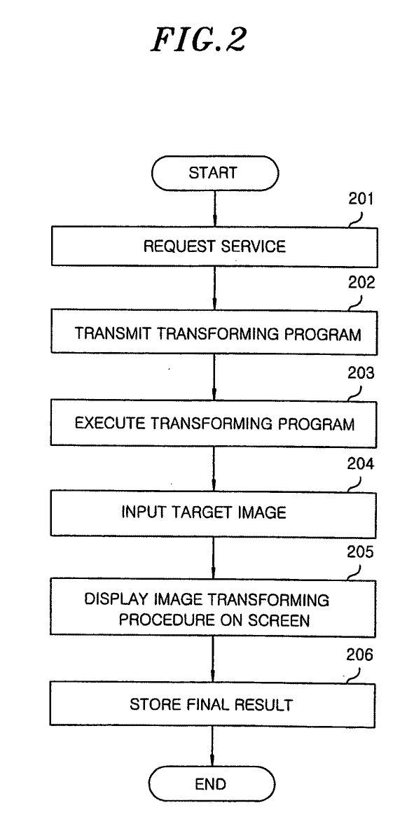

FIG. 2 is a sequence diagram illustrating an image creating procedure to which a high-end terminal based artistic transformation effect is applied in the image transforming service system according to an embodiment of the present invention.

Hereinafter, in a case of the high-end user terminal such as the desktop computer or the laptop computer, the image is directly created in the user terminal 104 in order to reduce load of the rendering server 101.

In other words, when the user requests the image transformation service to the web server 102 (S201), the web server 102 transmits the image transforming program to the corresponding user terminal 104 (S202). Then, the user terminal 104 executes the image transforming program transmitted from the web server 102 (S203) and reads a target image to be artistically transformed to the image transforming program to perform the image transformation (S204). During the image transformation, the procedure of transforming an image is displayed on a screen (S205), and a final result image is stored in a recording medium of the user terminal 104 (S206).

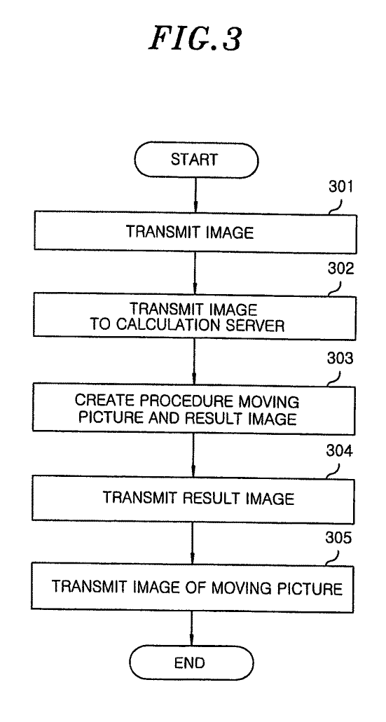

FIG. 3 illustrates the procedure of creating an image to which low-end user terminal based artistic effects are applied in the image transforming service system according to an embodiment of the present invention.

Referring to FIG. 3, in a case of the low-end user terminal such as a PDA or a mobile phone, the transformation is performed in the rendering server 101 and the result image and the moving picture are transmitted to the user terminal.

In other words, when the user having the low-end user terminal 105 transmits a target image to be artistically transformed from the user terminal 105 to the web server 102 (S301), the web server 102 transmits the image to the rendering server 101 (S302) and the rendering server 101 executes the image transforming program to create the moving picture and the result image (S303). When the transformation of the rendering server 101 is finished, the web server 102 transmits the result image to the user terminal 105 (S304) and transmits the moving picture to the e-mail address of the user when the user requests the moving picture (S305)

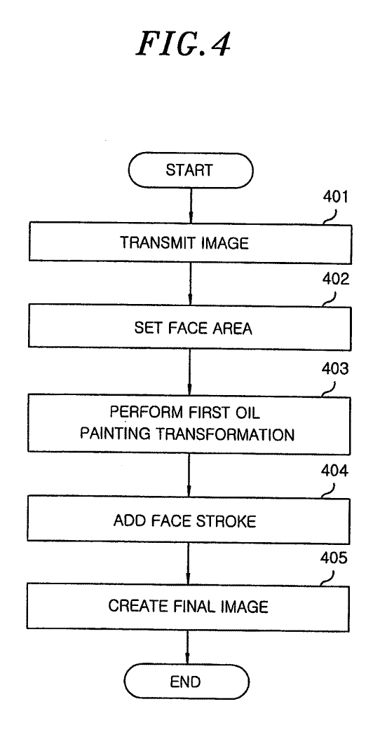

FIG. 4 illustrates a logical sequence of adding context-based selective strokes to a character in a photograph in terms of oil painting based artistic effects in the image transforming service system according to an embodiment of the present invention.

In the oil painting, when an image is input, a preset number of strokes is repeated to add strokes to the image. In this case, a position, a size, and color of the strokes are determined by analyzing the image when comparing the image with an original image, and a large number of strokes is assigned to a portion with a large difference from the original image. Although there is no particular problem for processing of a general image, an image including human faces has many problems. Since a great deal of strokes is assigned to depict a background, strokes to describe the characters are relatively reduced so that depiction of faces is deteriorated.

To the image transforming service system according to the embodiment of the present invention, face recognition is added to overcome the above-mentioned problem. In view of the operation, when the image is input (S401), the rendering server 101 performs the face recognition from the image (S402) to store the recognized face. The rendering server 101 performs an oil painting transformation (S403) and adds strokes to the recognized face's area (S404) to create a final image (S405). When there is no face or a face portion is too small, the face may be not recognized and additional calculation is not needed.

FIG. 5 illustrates examples of result images capturing stages in the procedure of creating the result image with the artistic rendering and of creating the moving picture of the procedure according to an embodiment of the present invention, and particularly illustrates procedures of creating images by applying an oil painting effect to a still life painting and by applying the template mosaic effect to a landscape photograph. As illustrated in FIG. 5, the procedure of creating an image is displayed to the user so that the user may be further interested in the artistic effects.

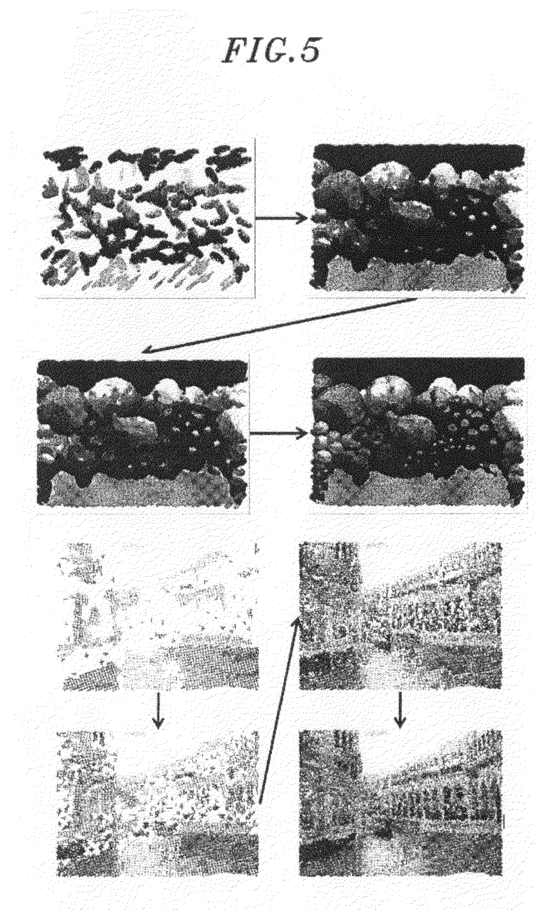

FIG. 6 illustrates a procedure of generating image mosaics based on the template to finally depict a tile image in a portion of an image.

As illustrated in FIG. 6, the rendering server 101 reads the tile image (S601) and compares the tile image with the background of the original image to rotate the tile image in an optimal direction (S602). The rendering server 101 extracts a template mask from the rotated tile image (S603) and determines whether the tile image is finally applied by comparing the template mask with an edge mask, an energy mask, and a writing mask (S604). When the tile image is determined to be put at a corresponding position, a color is read from a corresponding background to color and apply a shadow effect to the tile image (S605). These operations are repeated to create a final image (S606).

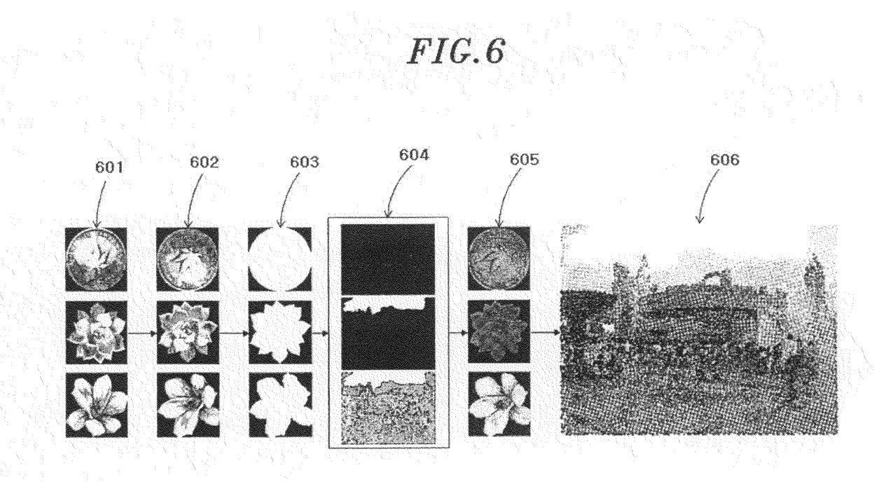

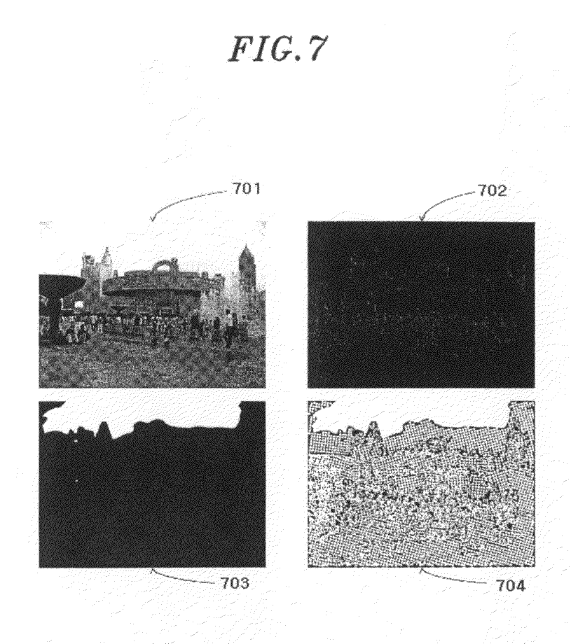

FIG. 7 illustrates three masks used in the template based image mosaic according to an embodiment of the present invention.

Referring to FIG. 7, a reference numeral 701 indicates an input image and a reference numeral 702 is an edge mask to create edges by applying an edge extracting algorithm such that the edges of objects are preserved in a mosaic image. When there are edges during determination of the tile position, a size of the tile image is adjusted so as to preserve the edges. A reference numeral 703 is an energy mask to apply a margin effect to an image and to empty a portion of the image when the portion has brightness higher than preset brightness. A reference numeral 704 is a writing mask to adjust the overlap of the tile images.

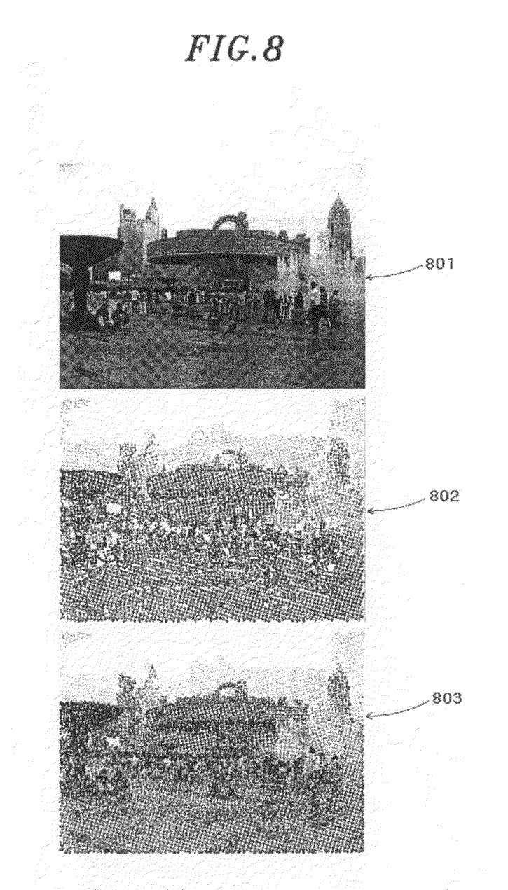

FIG. 8 illustrates result images in steps of creating the template based image mosaic including a first filling and a second detailed-depiction enhancing. In the first filling, the image is filled up such that a target image is divided into several areas based on color and brightness and the divisional areas are filled with the tile images, when the image is filled for example, the flood filling method can be used. The flood filling method searches repeatedly space and decides a good position to locate a tile while rotating a tile with comparing a template of a tile with three types of mask. In order to minimize gap between tiles, the size of a tile can be reduced. The positions of the tiles are determined through a comparison between the template extracted from the tiles and the masks. In this step, sections are maintained by three masks, the tile images are prevented from being overlapped, and the edges are preserved. In the second step, detailed depiction is enhanced such that the overlap of the tile images is adjusted based on information of brightness of the areas. That is, a position where the tile images are overlapped by comparing the result image with the input image is determined so as to enhance detailed depiction of the result image. And it is determined whether the overlap of the tile images is allowed based on a mask combining the energy mask with the writing mask. In the step of dividing the image and filling the divisional areas, the energy mask, the edge mask, and the writing mask are used, and in the step of determining a position and determining whether the overlap of the title images is allowed, the energy mask and the writing mask are used. The overlap is not permitted in the first step, but the overlap is adjusted in the second step based on the brightness information.

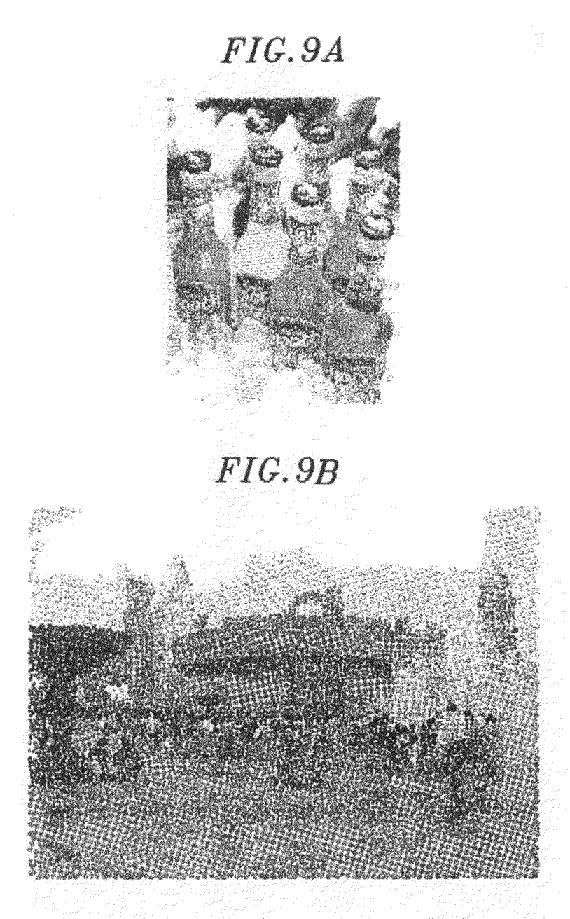

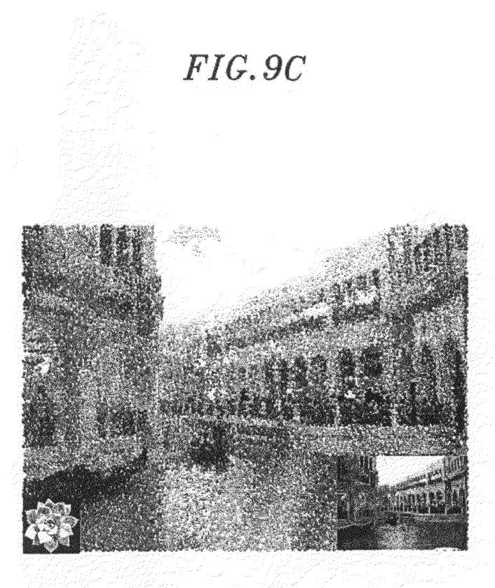

FIG. 8 illustrates an input image 801, an image 802 in which the first filling is finished, and an image 803 in which a final step is finished in the template based image mosaic creation. FIG. 9A to 9C illustrate various result images created by the template based mosaic proposed by the present invention.

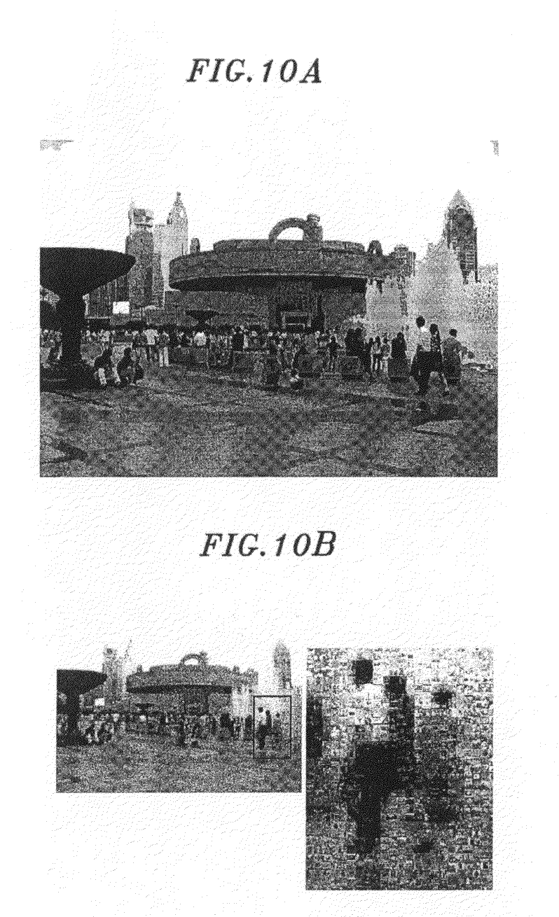

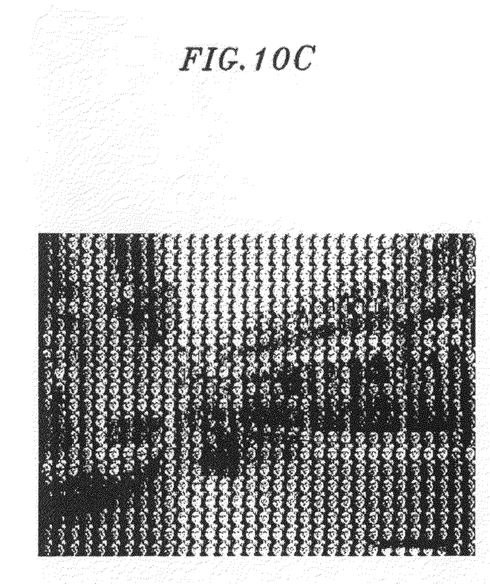

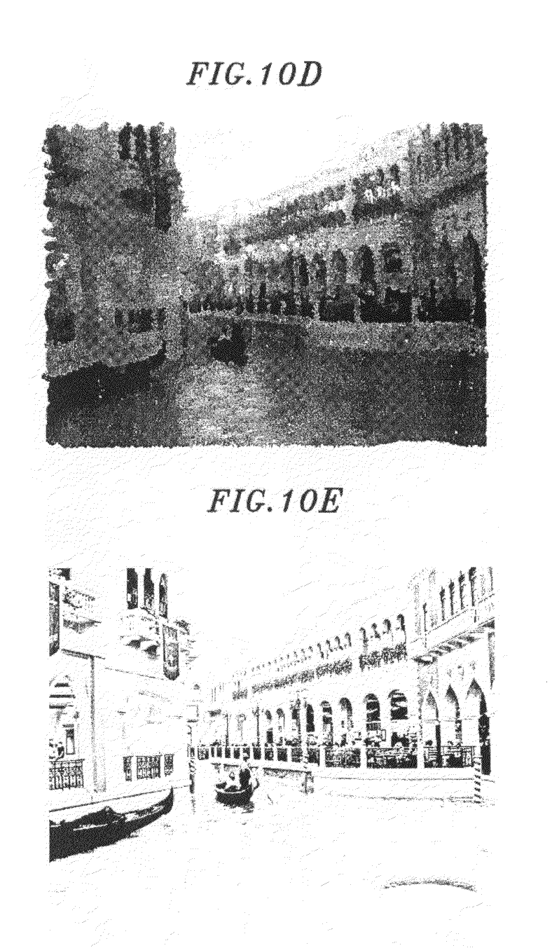

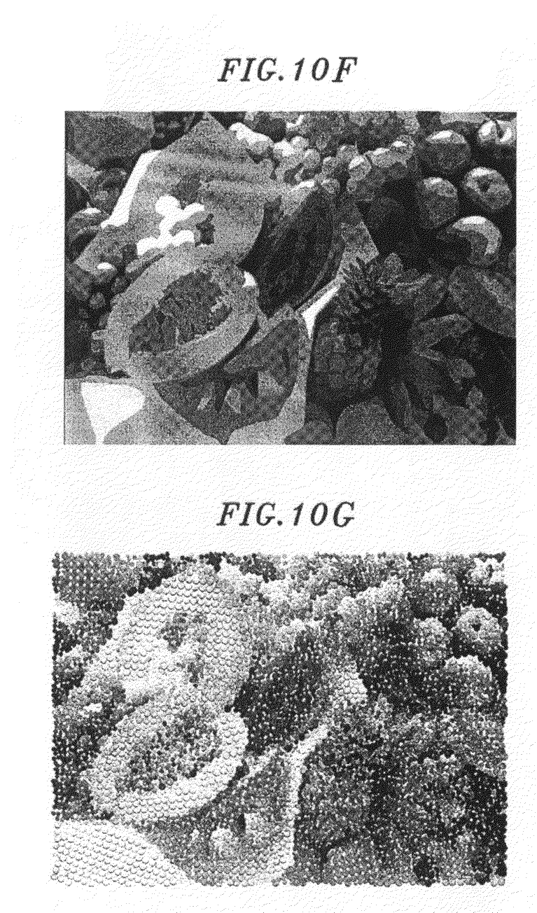

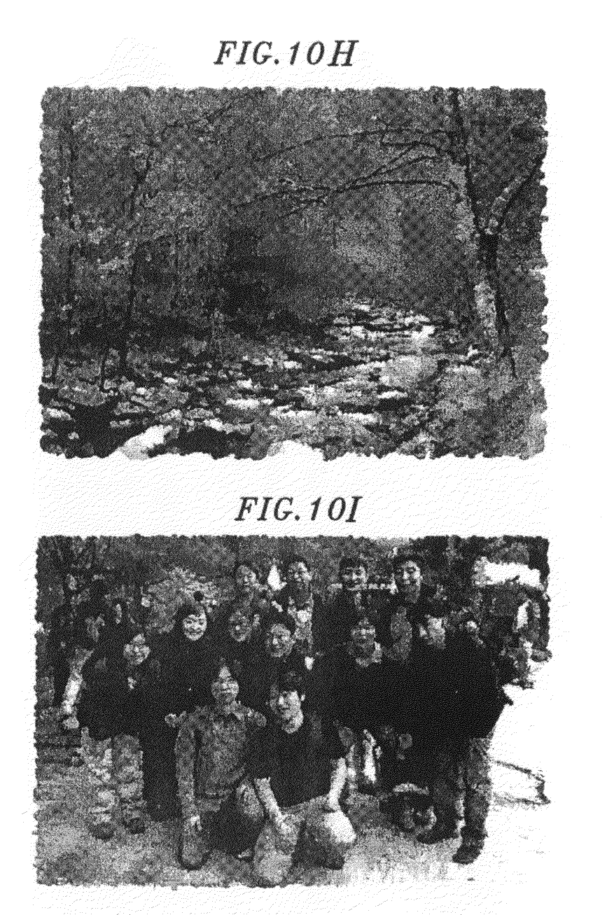

FIGS. 10A to 10I illustrate various result images created by artistic effects provided by the image transforming service system for providing an artistic image according to an embodiment of the present invention.

As illustrated in FIGS. 10A to 10I, according to the feature of the present invention, a 2D image photographed by a digital camera is transformed into an artistic image through image transformation performed by a computer so that a natural image such as an oil painting, a pen illustration, a cartoon, a dual picture, and a template mosaic as if a person directly depicts can be provided. In the transformation of the 2D image by various artistic effects, the procedure of creating the artistic image is displayed on a screen as if a person draws so that a user can view the procedure of creating the artistic image and can be interested in the artistic image.

While the invention has been shown and described with respect to the exemplary embodiments, it will be understood by those skilled in the art that the system and the method are only examples of the present invention and various changes and modifications may be made without departing from the spirit and scope of the invention as defined in the following claims.

What is claimed is:

1. An image transforming method of providing an image transformation service by applying a plurality of non-photorealistic transforming effects to an input image of a user, the method comprising:
receiving a request for an image transformation through a wired/wireless network from the user;
performing the image transformation at a user's terminal or a server according to a user's circumstance; and
creating a result image applied with the non-photorealistic image transforming effects.

2. The image transforming method of claim 1, further comprising creating a moving picture capturing a procedure of applying the non-photorealistic image transforming effects after creating the result image.

3. The image transforming method of claim 1, wherein in the creating the result image, when the non-photorealistic image transforming effects are applied, face recognition is applied to assign additional strokes to a face portion of a character in the input image containing the character such that depiction of the character is enhanced.

4. The image transforming method of claim 2, wherein, in the creating the moving picture, a procedure of creating the result image by applying a template mosaic and oil painting is stored in the form of a moving picture.

5. The image transforming method of claim 2, further comprising transmitting the moving picture capturing the procedure of creating the result image to a corresponding user through e-mail.

6. The image transforming method of claim 1, wherein, in the creating the result image, arbitrary free type tile images are applied to the input image to create a template mosaic image using a template of the tile images.

7. The image transforming method of claim 6, wherein a template mask is created by extracting the template of the tile images.

8. The image transforming method of claim 6, wherein an energy mask, an edge mask, and a writing mask are created from the input image.

9. The image transforming method of claim 8, wherein positions of the tile images are determined based on the energy mask, the edge mask, and the writing mask so as to adjust overlap between the respective tile images during the creation of the template mosaic image.

10. The image transforming method of claim 9, wherein the template mosaic image is created by:
dividing the input image into divisional areas by analyzing the input image and filling the divisional areas with a flood filling method;
selectively reducing a size of the tile images at edges of the divisional areas based on the energy mask and the edge mask;
determining a position where the tile images are overlapped by comparing the result image with the input image so as to enhance detailed depiction of the result image; and
determining whether the overlap of the tile images is allowed based on a mask combining the energy mask with the writing mask.

11. The image transforming method of claim 10, in the dividing the image and filling the divisional areas, the energy mask, the edge mask, and the writing mask are used, and in the determining a position and determining whether the overlap of the title images is allowed, the energy mask and the writing mask are used.

12. An image transforming system for providing an image transforming service by applying a plurality of non-photorealistic transforming effects to a two-dimensional input image of a user, the image transforming system comprising:
a rendering server transforming the two-dimensional input image into a desired image by applying non-photorealistic rendering to the two-dimensional input image;
a user terminal requesting the non-photorealistic rendering to the two-dimensional input image; and
a web server transmitting the request to the rendering server according to specification of the user terminal when the request is received and transmitting a result image to the user terminal, or transmitting an image transforming program to the user terminal such that the two-dimensional input image is transformed in the user terminal.

13. The image transforming method of claim 1, wherein in a case of a high-end user terminal, the image transformation is performed at the user's terminal, and in a case of a low-end user terminal, the image transformation is performed at the server.

14. The image transforming method of claim 13, wherein the high-end user terminal includes a desk-top computer and a laptop computer, and
wherein the low-end user terminal includes a portable PDA and a mobile phone.
